(19) United States
(12) Patent Application Publication
(10) Pub. No.: US 2002/0128902 A1
(43) Pub. Date: Sep. 12, 2002

(54) Voting apparatus and method with certification, validation and verification thereof

(76) Inventor: Athan Gibbs SR., Nashville, TN (US)

Correspondence Address: Carl M. Davis II, Baker, Donelson, Bearman & Caldwell, Suite 900, Five Concourse Parkway, Atlanta, GA, 30328, US

(21) Appl. No.: 09/843,042

(22) Filed: Apr. 25, 2001

Related U.S. Application Data
(60) Provisional application No. 60/274,704, filed on Mar. 9, 2001.

(51) Int. Cl. G06F 17/60

(52) U.S. Cl. 705/12

(57) ABSTRACT

A voting apparatus for display of candidates for offices in elective races and selective voting by a voter to elect one of said candidates in which a computer displays on a touch-sensitive video screen a sequential series of ballot screens corresponding to a race with candidate information block having a text name and/or a graphic image for each candidate. The voter touches the selected candidate information block, and a signal is sent to the central processor corresponding to the selected candidate. The vote is communicated to a tabulator for summing the votes for the candidate. The apparatus provides a voter validation receipt for voter certification, validation and verification of voting. An method of voting and for voters to certify, validate, and verify votes tabulated by the vote tabulation center is disclosed.

This application is a continuation-in-part of co-pending application Ser. No. ______, filed Apr. 5, 2001 as a continuation-in-part of Serial No. 60/274,704, filed Mar. 9, 2001.

### TECHNICAL FIELD

This invention relates to computerized apparatus and methods for use in assisting voters to vote while enabling voters to verify that the votes cast in elections were properly registered by the voting machine as well as received, recorded, counted and correctly reported by governmental agencies in the exact manner as intended by the voter.

### BACKGROUND OF THE INVENTION

In the Presidential election that was held in November of 2000, the public came to realize a fact that had long existed but which had not been widely known and appreciated. That fact was that there has long existed significant errors in state and federal elections. Exemplary of such errors are vote exclusions, vote additions and vote switching. Voters have simply had no viable way of checking to see if their votes have been recorded and counted in the manner in which they intended.

The public further became aware that ballots and the presentation on ballots of the candidates for election may confuse voters. A ballot known as a “butterfly” ballot caused particular problems for voters. In a butterfly ballot, the candidates for election are listed in two columns on opposing pages. A central column includes a vote field associated with each candidate. An arrow associated with each of the candidates points to the appropriate vote field for that candidate. The voter marks the vote field, or in the case of computer punch card ballots, uses a pin to push a perforated chad from the card at the designated vote field. The political parties had reviewed and approved such a butterfly ballot for use in the recent election. Subsequent to the election, it was determined that the butterfly configuration was surprisingly confused by a number of voters who either mis-marked the ballot by voting for a candidate other than the one they wanted, or by double-voting for the office in the race by considering candidates on each opposing page.

Accordingly, it is seen that a need remains for an improved voting apparatus and method that allows the voter to verify that his or her ballot selection has been recorded by the voting machine correctly; as well as being received, recorded and counted by government agencies in the exact manner as intended by the voter. It is to the provision of such therefore that the present invention is primarily directed.

### SUMMARY OF THE PRESENT INVENTION

The present invention meets the need in the art by providing a voting apparatus that displays information about the candidates for offices in elective races and for selective voting by a voter to elect one of said candidates in which a central processor operates to display a sequential series of ballot screens. Each ballot screen corresponds to one elective race and includes a candidate information block having a text name and a graphic image associated with each of at least one candidate for election by voters in the elective race. A touch-sensitive video display monitor communicates to the central processor a signal representative of a selected location of a touch by a voter, which touch is made at the display of the candidate information block for whom the voter intends to vote. The central processor detects which of the at least one candidate information blocks was selected by the voter. A communicator transfers the vote to a tabulator for summing the votes for the selected candidate.

In another aspect, the present invention provides a method of voting for candidates for office in at least one elective race by a voter, comprising the steps of:

(a) displaying a sequential series of ballot screens, each ballot screen corresponding to one elective race and including a candidate information block associated with each of at least one candidate for election by voters in the elective race; and

(b) the voter touching a touch-sensitive video display monitor to communicate a signal representative of a selected location of a touch by a voter to a central processor, which touch is made at the display of the candidate information block for whom the voter intends to vote,

whereby the central processor detects which of the at least one candidate information blocks was selected by the voter.

Objects, advantages, and features of the present invention will become apparent upon a reading of the following detailed description in conjunction with the drawings and the appended claims.

### BRIEF DESCRIPTION OF THE DRAWINGS

FIG. 1 depicts in plan view a front side of a voter validation receipt issued in accordance with principles of the invention.

FIG. 2 depicts in plan view a back side of the voter validation receipt.

FIG. 3 illustrates a first voter validation screen of a state-level election reporting web site accessible through a computerized network, in accordance with the present invention.

FIG. 4 illustrates a second voter validation screen of a state-level election reporting web site accessible through a computerized network, in accordance with the present invention.

FIG. 5 illustrates a third voter validation screen of a state-level election reporting web site accessible through a computerized network, in accordance with the invention.

FIG. 6 illustrates a first voter validation screen of a national-level election reporting web site accessible through a computerized network, in accordance with the present invention.

FIG. 7 illustrates a second voter validation screen of a national-level election reporting web site accessible through a computerized network, in accordance with the present invention.

FIG. 8 illustrates a third voter validation screen of a national-level election reporting web site accessible through a computerized network, in accordance with the invention.

FIG. 9 is a schematic illustration of the flow of votes from local-level voting to superior-level vote tabulation centers according to the present invention.

FIG. 10 is a schematic illustration of a voting apparatus according to the present invention.

FIG. 11 illustrates an initial voting screen for registering a vote in an election using the apparatus illustrated in FIG. 10.

FIG. 12 is a screen image of a subsequent race in an election using the voting apparatus illustrated in FIG. 10.

FIG. 13 is a screen image of a proposition ballot for use with the voting apparatus illustrated in FIG. 10.

FIG. 14 is a summary screen prior to the voter casting his ballot using the apparatus illustrated in FIG. 10.

### DETAILED DESCRIPTION OF THE PRESENT INVENTION

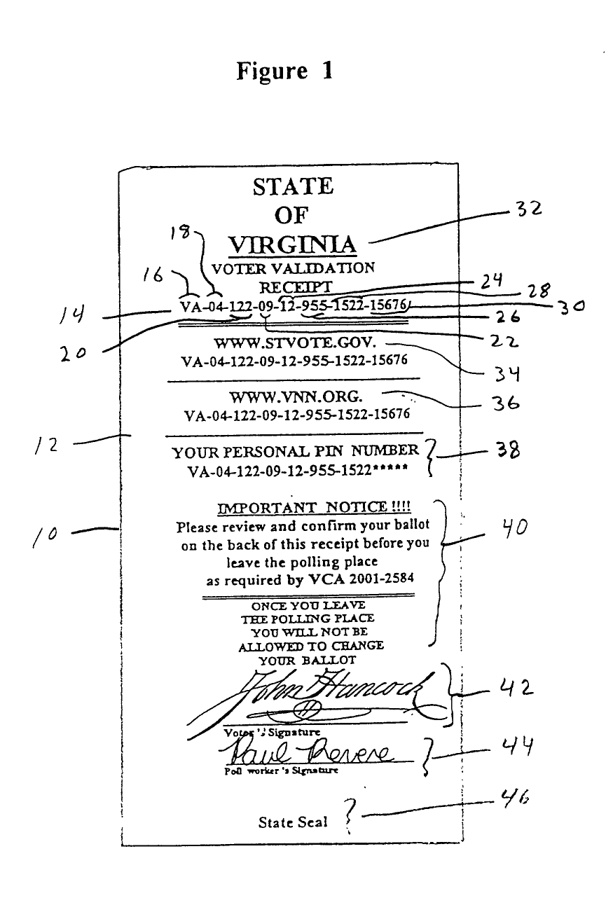

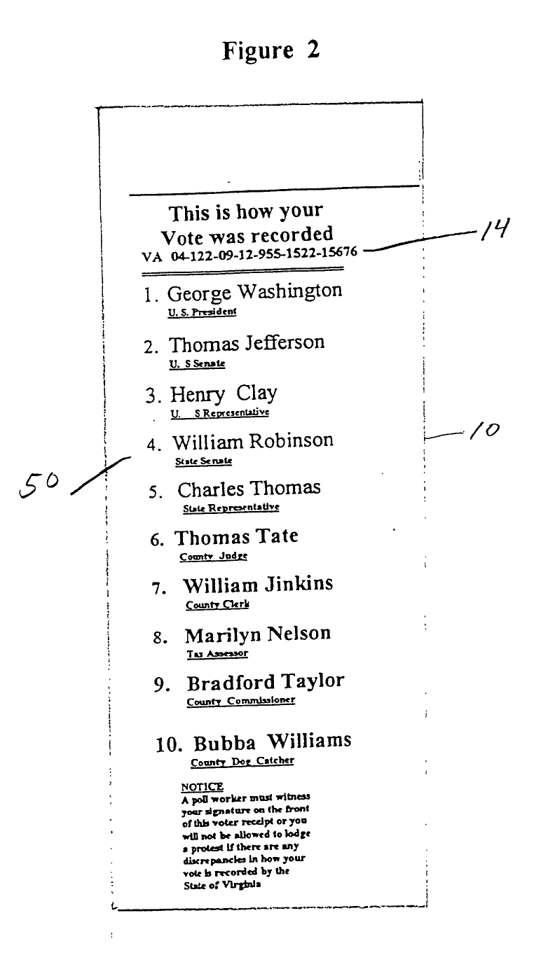

With reference to the drawings, in which like elements have like reference numerals throughout the several drawings identified above, FIGS. 1 and 2 illustrate in plan views a front and a back side, respectively, of a voter validation receipt 10, in accordance with the present invention. The voter validation receipt 10 is dispensed to each voter after voting. The voter validation receipt 10 is printed on each side with information relevant to the particular voter. In an alternate embodiment, the voter validation receipt 10 is printed in two parts. FIG. 1 illustrates a front side 12 of the voter validation receipt 10. Each voter validation receipt 10 is assigned a unique voter validation number generally 14. In the illustrated embodiment, the voter validation number 14 is computer generated. The voter validation number 14 includes several fields of identifiers of information as to the particular voting place of the voter. The identifiers may be alphabetical characters and/or numeric, with separators between adjacent fields for convenience. Each of the fields within the voter validation number facilitates an audit function that can be used to detect voter error, as well as the errors and unscrupulous activities on the part of others. However, procedures are included to prevent any ballot selection from being traced back to any voter.

The present invention is contemplated for use with voting generally, but is particularly adapted for use where the geographic area involved is divided into superior and inferior regions. For example, the United States is divided into discrete states; the states subdivide generally into counties of smaller areas; the counties further subdivide into local voting precincts. In the illustrated embodiment, the fields of identifiers or codes within the voter validation number 14 represent: (a) the state code 16, (b) the county code 18, and (c) the precinct code 20, in which the voter voted, together with (d) the voting machine code 22 used by the voter, (5) a poll worker's number 24 who validates the voter, (6) the time of day 26 of the vote by the voter, (7) the cumulative number of votes 28 on the particular voting machine 22 at the time the voter's vote is cast and (8) the cumulative number of votes 30 cast in the precinct at the time the voter's vote is cast.

Embodied in the system are a number of audit procedures, system logic, reasonableness tests and checks designed to identify voter errors and vote fraud. The time and place of every vote cast within the state can be identified and accounted for thorough a time and place audit routine, while at the same time maintaining the absolute anonymity and confidentiality of every voter.

The front side of the voter validation receipt 10 further includes an identification of the particular state generally 32. The voter validation receipt 10 includes an identifier as to a state tabulation web site 34 and a national tabulation web site 36, together with a personal identification number (PIN) 38. The PIN 38 is used by the voter, as discussed below, to access the web sites 34, 36 to verify the voter's votes and the votes inclusion in the tabulation of votes for the candidates selected by the voter. Space is provided for instructions on review 40, together with a voter's endorsement 42 and a poll worker's endorsement 44 and seal 46 of the voter validation receipt 10.

As illustrated in FIG. 2, the backside (or the second part) of the voter validation receipt 10 lists the candidates generally 50 for whom the voter voted, including the name and the office.

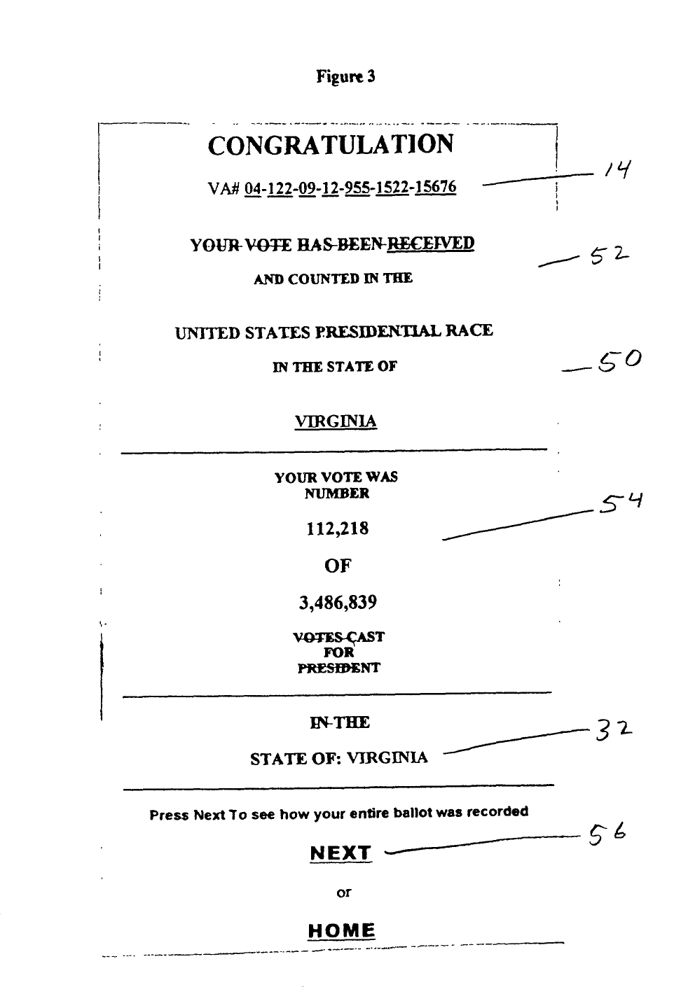

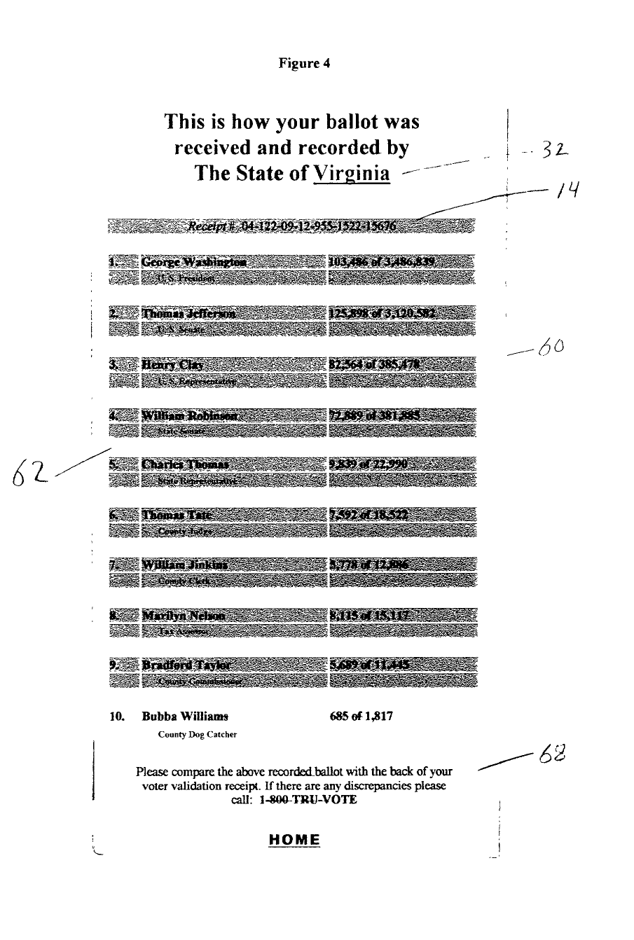

FIG. 3 illustrates a first voter validation screen 50 of a state-level election reporting web site accessible through a computerized network, in accordance with the present invention. Upon presentation of appropriate security mechanisms, the first voter validation screen 50 includes a display of the particular voter's validation receipt number 14, together with a report 52 that the voter's vote was included in the national election for the particular state. The report 52 includes a statement 54 as to the sequential number of the vote the voter represents in the total number of votes for the candidate. A button 56 allows the voter to move to the second voter validation screen 60 of the state-level election reporting web site accessible through a computerized network, illustrated in FIG. 4. The second voter validation screen 60 includes a report generally 62 of the candidates and offices for whom the voter voted, together with the sequential number 64 of the vote by the voter for the candidate and the total number of votes 66 for the candidate. An instruction message 68 explains to the voter how to report discrepancies between the information on the voter validation receipt 10 and the information on the voter validation screens 50, 60.

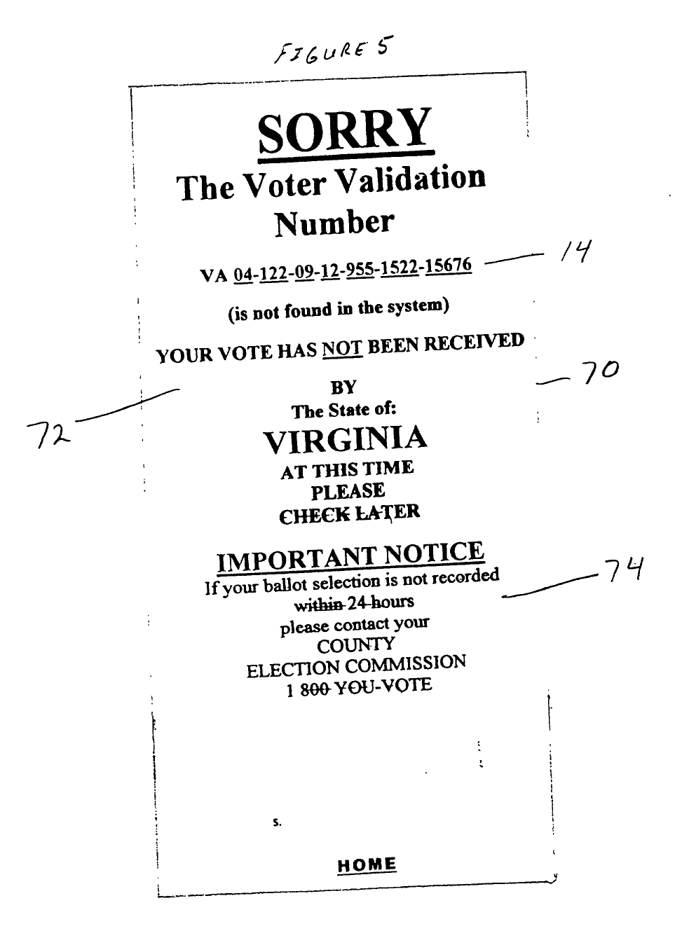

FIG. 5 illustrates a third voter validation screen 70 of the state-level election reporting web site accessible through a computerized network, in accordance with the invention. The third voter validation screen 70 displays the voter validation number 14, together with a statement 72 that the vote has not been received, such as by state election tabulation center. An advisory message 74 tells the voter how to report that the voter's selections have not been received, if after a reasonable time period following the voting.

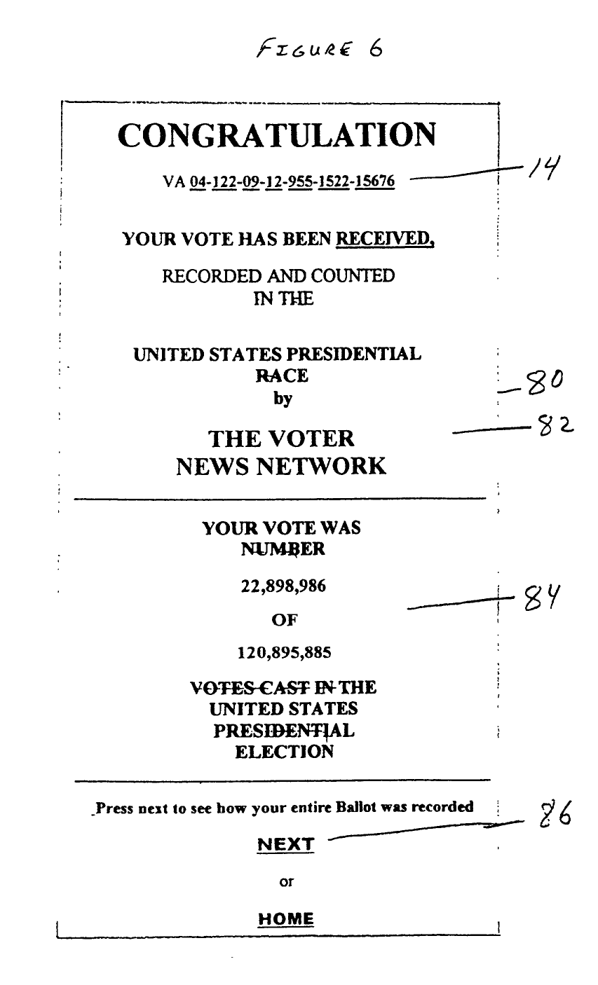

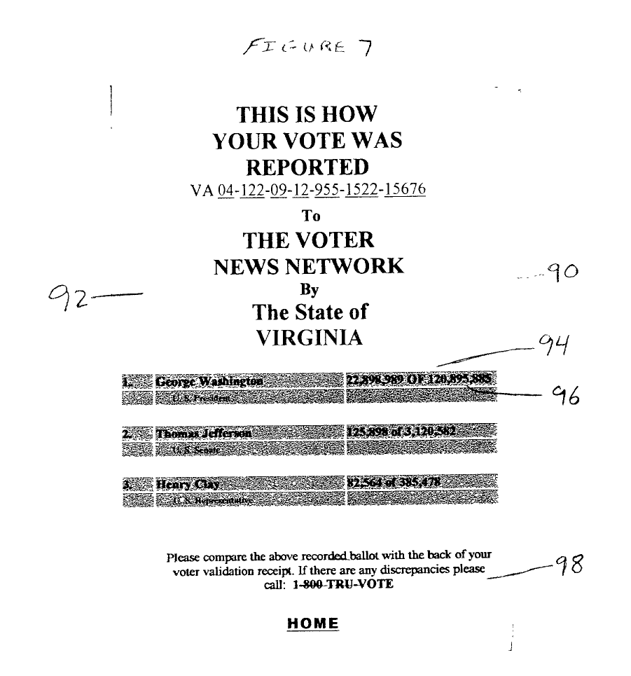

In the event of national elections, the voter's votes for national office candidates are reported to a national tabulation center. The tabulation of the particular vote is likewise verifiable through a national tabulation web site, such as be accessed through a computer network. FIG. 6 illustrates a first voter validation screen 80 of the national-level election reporting web site accessible through a computerized network, in accordance with the present invention. Upon presentation of appropriate security mechanisms, the voter validation screen 80 displays the particular voter's validation receipt number 14, together with a report 82 that the voter's vote was included in the national election tabulation. The report 82 includes a statement 84 as to the sequential number of the vote the voter represents in the total number of votes for the candidate. A button 86 allows the voter to move to a second voter validation screen 90 of the national-level election reporting web site, as illustrated in FIG. 7.

The second voter validation screen 90 includes a report generally 92 of the candidates and national offices for whom the voter voted, together with the sequential number 94 of the vote by the voter for the candidate and the total number of votes 96 for the candidate. An instruction message 98 explains to the voter how to report discrepancies between the information on the voter validation receipt 10 and the information on the voter validation screens 80, 90.

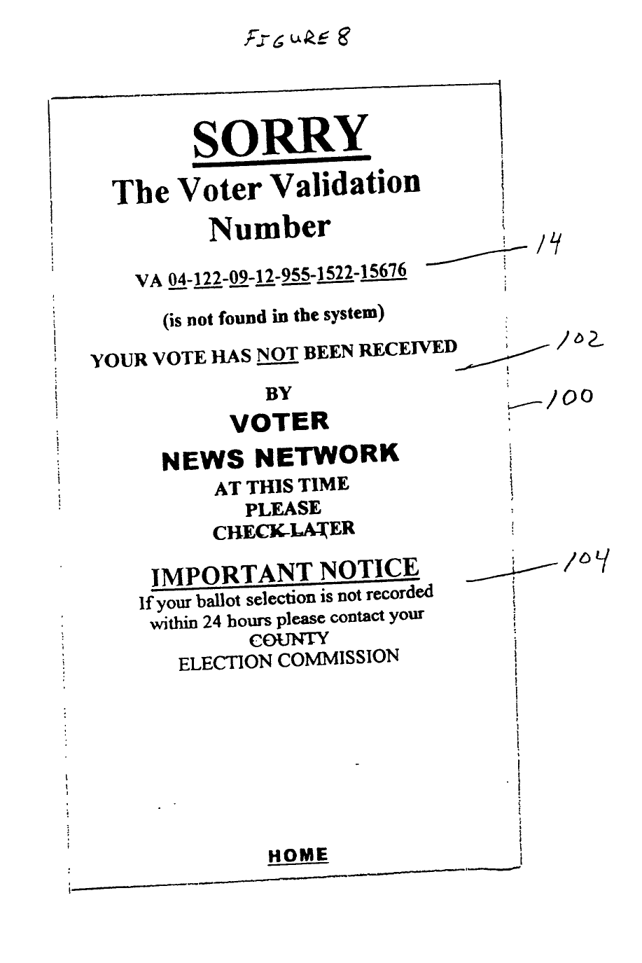

FIG. 8 illustrates a third voter validation screen 100 of the national-level election reporting web site accessible through a computerized network, in accordance with the invention. The third voter validation screen 100 displays the voter validation number 14, together with a statement 102 that the vote has not been received. An advisory message 104 tells the voter how to report that the voter's selections have not been received, if after a reasonable time period following the voting.

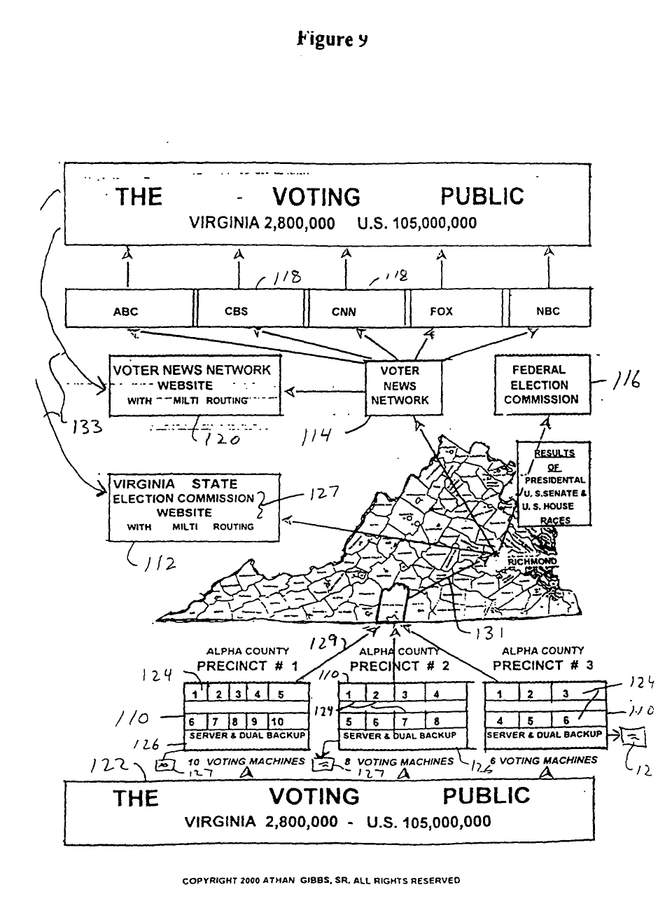

FIG. 9 is a schematic illustration of the flow of votes from local-level voting precincts generally 110 to superior level vote tabulation centers (112 for the state tabulation center and 114 for the national tabulation center), according to the present invention. The votes are communicated from the state tabulation center 112, such as the state election commission, to the federal election commission 116. The national tabulation center 114 communicates the tabulated votes to news organizations generally 118 and/or to a network of news services 120. The voters 122 initiate the vote tabulation by voting at particular voting machines 124 at the precincts 110. In the illustrated embodiment, a controller 126, such as a computer server, operates the voting machines 124, monitors the voting, and creates the voter validation number. A printer 127 generates the voter validation receipt 10. The controller 126 communicates 129 the votes to the county election department, which communicates 131 with the state tabulation center 112. These tabulated votes are in turn reported to the national tabulation center 114. FIG. 9 accordingly shows the flow of votes or ballot selections from the voting public 122 through (a) voting machines 124 in (b) each precinct 110 within the state to (c) the state election commission or tabulation center 112 generally located at the state's capital where the voters data are compiled and the result is made accessible to the voter on the state's website (see generally 127). This information is also made available to independent national voter reporting agency 114. However, the built-in security measures allow only the voter to access and review his own ballot selection, thus preserving the anonymity and confidentiality of the voter.

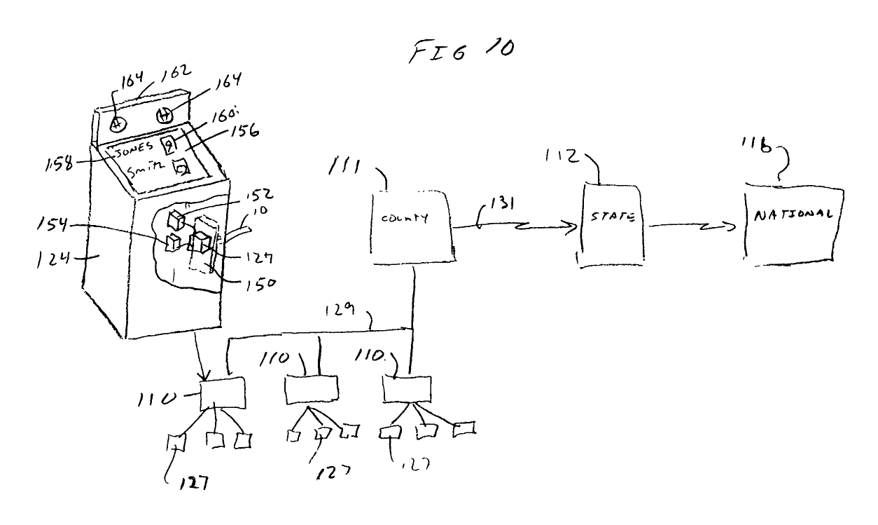

FIG. 10 is a schematic illustration of an improved voting apparatus 124 according to the present invention. In the illustrated embodiment, the voting apparatus 124 includes a CPU 150 containing the operating and application software for operating the voting apparatus 124. The printer 127 is driven by the CPU 150 and includes a dispensing slot for printing the voter validation receipt 10. The voting apparatus 124 includes a touch-sensitive video screen 156 upon which candidates names 158 and photographs 156 are displayed during the voting process, as discussed below. The CPU 150 also communicates with paired, dual and mirror-image disc drives 160. In the illustrated embodiment, a backboard 162 includes speakers/headphones 164, for a purpose as discussed below.

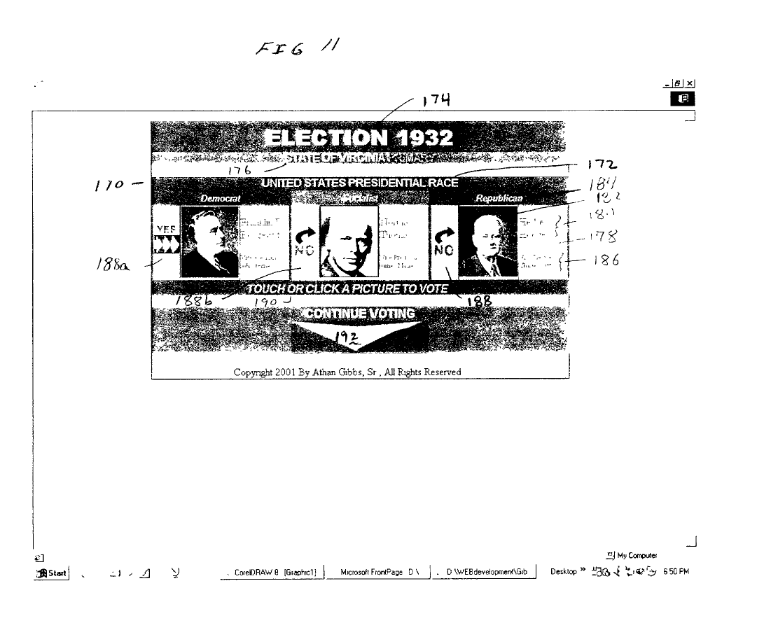

FIG. 11 illustrates a display screen 170 for an election race. The display screen 170 includes a race identifier 172 as well as the election 174 and the jurisdiction of the election 176. The screen 170 includes candidate information blocks generally 178. Each candidate information block 178 includes text of the candidates name 180, a photograph 182, and a party affiliation 184. In addition, some textural explanation generally 186 may be required. In the illustrated embodiment, the vice-presidential candidate is listed in the explanation 186. The candidate information block 178 also includes a graphic vote indicator 188. A candidate 180 for whom the voter intends to vote is indicated by a positive graphic 188a including the word “Yes” with pointing arrows. The other candidates have a graphic with the word “No” and an arrow, as indicated at the negative graphic 188b. An instruction line 190 tells the voter how to use the screen 170. A continue voting button 192 is activated to move to the screen for the next race at issue.

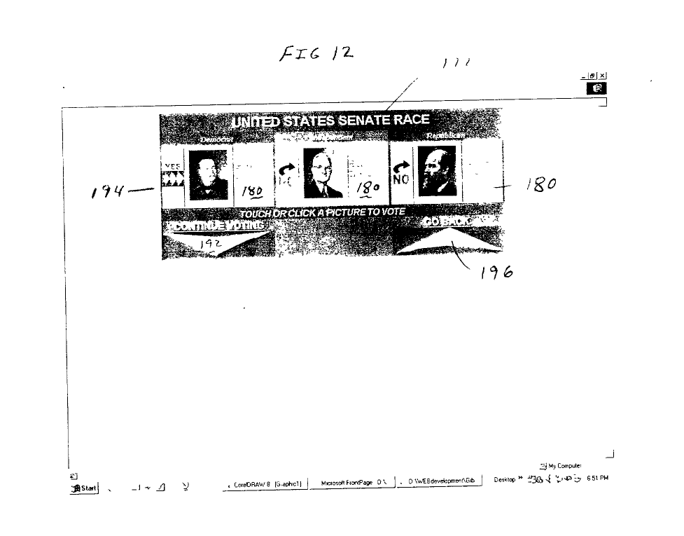

FIG. 12 illustrates a screen 194 for a subsequent race. The screen 194 includes the race identifier 172 as well as candidate information blocks 180 for each candidate in the race. The continue voting button 192 directs control of the voter apparatus 124 to a subsequent screen for an additional race to be voted on by the voter in the particular precinct. A go-back button 196 enables the voter to move to prior screens for prior races to review the selection of the candidate by the voter.

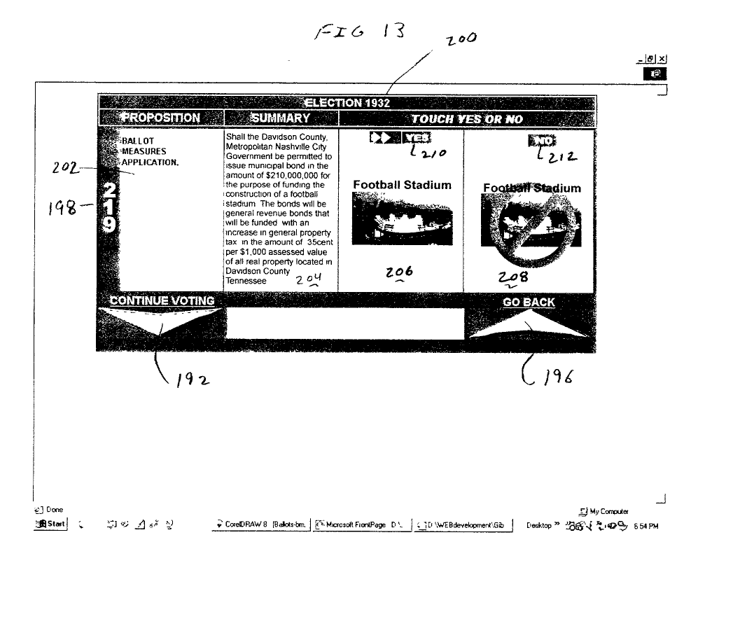

FIG. 13 illustrates a screen 198 for proposition or initiative questions. The screen 198 includes an election identifier 200, a proposition title 202, and a summary or statement of the proposition 204. The screen 198 further provides two opposing graphics generally 206 and 208 with vote buttons 210, 212 indicating a vote in favor or against the proposition.

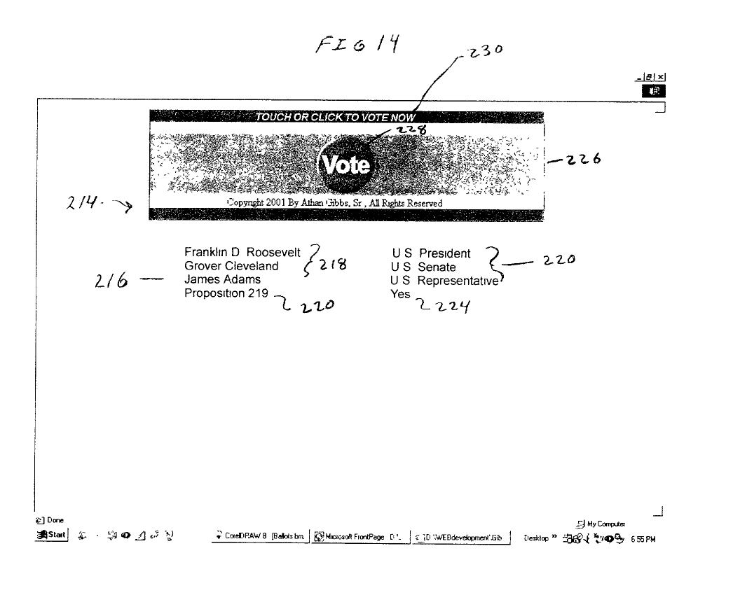

FIG. 14 illustrates a screen 214 which includes a summary 216 of the candidates generally 218 and the offices generally 220 as well as the propositions generally 222 and the vote 224 intended by the voter. A vote window 226 includes a vote button 228 and instructions 230.

The election voting apparatus and method of the present invention enables certification, validation, and verification of votes cast by voters. With reference to FIG. 1 and to FIGS. 10 and 11, the voter is initially approved at the precinct to vote, and the voter proceeds to the voting machine 124. The video screen 156 displays the candidates names 158 and/or photographs 156. The graphic vote indicators 188 in each candidate information block 178 are blank. In an alternate embodiment, the vote indicators were initially to be set to the negative graphic, or “No”. The voter reviews the candidate's name 180, the photograph 182, and the party affiliation 184. Using the touch-sensitive video screen 156, the voter touches the video screen at the selected candidate selection block 178. The touch-sensitive screen communicates a signal to the CPU 150 to indicate a vote for that particular candidate. The graphic 188 for the selected candidate becomes the word “Yes” with pointing arrows, as illustrated at 188a. The other candidates are designated by the word “No” and the arrow, as indicated at the negative graphic 188b. Should the voter change intentions, and subsequently push the candidate information block 180 for another of the candidates, the graphic 188 for the previously selected candidate changes to “No” and the other selected candidate has the positive graphic 188a with the word “Yes”. In an alternate embodiment, the voter may push an activation button (not illustrated) and have an audible message communicated through the speakers/headphones 164. Preferably, the audible message is the name of the candidates in the race.

The voter pushes the voting button 192 to move the screen 156 to display the next race at issue. FIG. 12 illustrates a representative screen for subsequent races. The voter again considers the candidates information block 178, and selects a candidate 180. The go-back button 196 enables the voter to have the screen 156 display prior races for review. The button 192 directs control of the voter apparatus 124 to the subsequent screen for additional races to be voted on.

With reference to FIG. 13, proposition or initiative questions are likewise voted on using the touch-sensitive video screen 156. The voter reviews the proposition title 202 and the summary or statement of the proposition 204. In the illustrated embodiment two opposing graphics generally 206 and 208 are used, these show a pro-proposition graphic 206 and an anti-proposition graphic 208. In the illustrated embodiment, the proposition relates to construction of a football stadium and the graphic 206 is an illustration of the stadium. The opposing graphic 208 includes the universal “No” symbol superimposed over the graphic 208. The voter indicates the vote by pressing the touch-sensitive video screen 156 at the button 210 or 212. The continue voting button 192 transfers the screen to subsequent races.

After the voter completes voting, the ballot for the particular precinct, the screen 214 illustrated in FIG. 14 provides a summary 216 of the candidates and the offices for which the voter voted. The summary 216 includes the propositions and the vote intended by the voter. The voter then pushes the video screen 156 at the vote button 228, in accordance with the instructions 230. At this point, the vote is recorded by the CPU 150 and stored on mirror-image dual disk drives 160. The printer 127 prints the voter validation receipt 10 which is dispensed outside of the housing for the voting apparatus 124. In an alternate embodiment, the screen 214 includes a selection button, whereby the voter may decline to have the voter validation receipt 10 printed.

With reference to FIG. 9, the voter may vote and have the voter validation receipt 10 certified. The voter may then certify and validate the vote intended, as discussed below. The voter attends the assigned precinct 110 and votes. Preferably, the voting apparatus 124 discussed above is used. The computer controller 126 located locally at the precinct 110 or at county elections office operates to provide the voter validation receipt 10, illustrated in FIGS. 1 and 2, with the voting apparatus 124 connected by network communications cable with local machine voting. The CPU 150 provides the printed voter validation receipt 10. The voter validation receipt 10 is the first and primary source of evidence that the voter has in order to prove that the voter did vote and the candidate or ballot question for whom or which the voter intended to vote. The computer controller 126 generates the voter validation number 14. This is printed on the front side of the voter validation receipt 10, together with the PIN 38 and on the back or second part, with the candidates and office for whom the voter voted. Upon receiving the printed voter validation receipt 10, the voter reviews the printed names 48 on the back (or the second part) of the voter validation receipt. Upon assuring himself or herself that the list of candidate names 48 are the persons for whom the voter voted, ie., the candidates listed are correct, the voter signs the voter validation receipt 10 on the front in the field for the endorsement 42, thereby certifying the vote. In the illustrated embodiment, the voter signs the voter validation receipt 10 in the presence of a poll worker. The poll worker also signs in the field for poll worker endorsement 44 as a witness and validates the receipt as with a seal 46 and with the poll worker's number.

Additionally, every vote cast within the state is automatically assigned a sequential number as the voter's ballot selections are transmitted periodically (for example, hourly) from each precinct to a superior tabulation center, such as a state election commission. This is an internal audit tool to assure that every vote that was cast in the state, including absentee votes can be accounted for. Likewise, every vote is sequentially numbered a second time as each state reports its vote totals to a superior central vote receiving center, for example, a network of news organizations that collects and tabulates votes for inclusion in national federal elections. In an alternate embodiment, the state votes are communicated to an official national tabulation center.

At this point, the voter will have fulfilled his responsibility in the voting process. Within a short period of time thereafter, the voter can log onto a computer network, such as the particular state's website on the global worldwide web or other interactive computer network generally 133, in order to verify his vote. With reference to FIG. 3, the voter enters his voter validation number 14 shown on the voter validation receipt 10 and the personal PIN number 38. The personal PIN number 38 is shown on the voter validation receipt. In a preferred embodiment, the PIN number 38 is printed on a perforated portion of the voter validation receipt 10, so that it can be separated from the receipt. The personal PIN number 38 is preferably randomly generated by the computer at the time of voting or can be designated by the voter, such as the last four digits of an identification number familiar to the voter such as the Social Security number.

Upon accessing the state website, the voter then views state screen 52 illustrated in FIG. 3. This screen 50 includes the report 52 that provides confirmation to the voter that his vote was received recorded and counted by the state and tells what number 54 his vote was of the total number of votes cast.

If desired, the voter can enter the personal PIN 38, and with the button or link 56, access the second state screen 60 illustrated in FIG. 4. The second state screen 60 reports how the entire ballot for the voter was received, recorded and counted. The state screen 60 shows what number 64 the voter was out of the total number of votes 66 cast in each race. The second column of number 66 headed “total number of votes” will be the same for every voter in the state who cast a vote in each of the respective races. These totals serve as one of the built-in automatic check points which assure that all votes that were cast in the state were counted. If an error is detected by a ballot not being included in the state's grand total in any of the races, the affected voter is first to know, and the state election commission can be the second to know if the voter acts to notify the commission.

It is to be appreciated that voters can make printouts of the screens for their records, if desired. The printouts of state screen 50 and state screen 60 provide the voter with additional evidence that the person's vote was received by the state and that the vote was recorded and counted in the manner intended. Any officially cast vote not included in the state's grand totals can be corrected by presenting the county election commission with a copy of the officially signed, witnessed and sealed voter validation receipt 10. The affected voter's ballot can then be entered manually by the county and the vote added to the state's grand total.

FIG. 5 illustrates the state screen 70 that is displayed if the voter's vote has not yet been received by the central voting tabulating center 112 at the time the voter is checking whether his vote was received. The voter can check at a later time. If the vote is not indicated as received after a period, such as 24 hours, the voter should contact his county election commission.

The state vote is communicated to the national tabulation center 114. The voter may likewise contact the website of the national tabulation center 114, similarly to contacting the state website as discussed above. This enables the voter to determine how his vote was counted nationally. FIG. 8 provides the screen 100 that is displayed if the voter's vote has not yet been received by the national tabulation center. FIG. 6 illustrates the screen 80 that verifies the voter's vote was included in the national tabulation. FIG. 7 illustrates the screen 90 that provides the summary of the vote reported by the state tabulating center 112 to the national tabulating center 114. The voter can compare the information on the voter validation receipt 10 to the reported vote to verify proper and correct recording of his vote. If in error, the voter may contact the elections commission for correction.

The flow chart in FIG. 9 shows the flow of the data of the voter's ballot selections from the voting public through (a) the voting machines 124 in (b) each precinct 110 to (c) the state election commission 112, typically located at the state's capital, where the voter's data are compiled and posted on the state's website. This information is also made available to the national voter reporting agency 114, including media agencies such as the “Voter News Network” that compiles the result of national elections. The national tabulation center 114 also posts the result to its website for each voter to review, as discussed above. Voters access the web site with the use of the voter validation numbers and the personal PIN numbers. The voters verify that the vote was recorded and counted in the exact manner intended. The voter can print out the ballot selection and compare it with information on the back of the voter validation receipt 10 received at the voting booth. Errors in balloting, tabulating, and reporting can be determined and corrective action taken.

In summary, the present invention provides the voting system method and apparatus for (1) certification, (2) validation, and (3) verification of every voter's ballot selections. The ballot selection is certified by use of the voter's endorsement or signature 42 on the voter validation receipt 10. The voter's ballot selection is validated with the poll worker's endorsement or signature 44, the seal 46, and the voter validation receipt number 14 containing indicia of voting (machine number, precinct, and time) particular to the voter. The voter's ballot selections are verified by the voter and only the voter through the state, national or other web sites 112, 114, accessed using the voter validation receipt number 14 and the PIN 38. It thus is seen that a vote verification method and apparatus is now provided that enables voters readily to verify whether or not the vote has been properly counted. In the event of detected error, the voter may quickly bring the error to the attention of the authorities for correction. The anonymity and confidentiality of the voting process is maintained. Though the preferred embodiment uses a world wide interactive computer network, it should be understood that a telephone counterpart may readily be used with voice activated readouts of all the data shown in the drawings, and with the associated printouts and reports.

The voter validation system can be funded via two levels of voluntary taxpayer checkoff. At the federal level, taxpayers can have the option to designate a dollar amount of their federal tax liability to a specified fund. The checkoff is similar to the current Presidential Election campaign fund. Unlike the Presidential election campaign fund, when taxpayers do not have a tax liability they cannot designate taxes to go to the fund. However, many taxpayers have no final tax liability as they receive substantial refunds. Preferably these taxpayers will have the option to contribute to the fund. Likewise, states can establish such election funds.

The invention of the improved voter apparatus and method, together with voter certification, validation, and verification apparatus and method, have been described in detail with particular references to the preferred embodiments thereof. It should be understood that many modifications, additions and deletions, in addition to those expressly recited, may be made thereto without departure from the spirit and scope of the invention as set forth in the following claims.

What is claimed is:

1. A voting apparatus for display of candidates for offices in elective races and selective voting by a voter to elect one of said candidates, comprising:
a central processor operative to present for display a sequential series of ballot screens, each ballot screen corresponding to one elective race and including a candidate information block having a text name and a graphic image associated with each of at least one candidate for election by voters in the elective race;
a touch-sensitive video display monitor communicating a signal representative of a selected location of a touch by a voter to the central processor, which touch is made at the display of the candidate information block for whom the voter intends to vote,
whereby the central processor detects which of the at least one candidate information blocks was selected by the voter; and
a communicator to transfer the vote to a tabulator for summing the votes for the selected one of the at least one candidate.

2. The voting apparatus as recited in claim 1, further comprising a pair of mirrored storage devices to record the summation of the votes by the tabulator.

3. The voting apparatus at recited in claim 1, wherein the central processor further displays a proposition screen having a recitation of the proposition and graphics images representative of the proposition and the negative of the proposition.

4. The voting apparatus as recited in claim 1, further comprising a printer operatively connected to the central processor for printing a voter validation receipt.

5. The voter apparatus as recited in claim 1, further comprising a communications device for connecting the central processor to a vote tabulation center over a telecommunications network, whereby the summation of votes is communicated.

6. The voter apparatus as recited in claim 1, further comprising at least one speaker/headphones connected to the central processor for making an audible recitation to the voter of the names of the candidate prior to the voter voting.

7. The voter apparatus as recited in claim 1, wherein each ballot screen in the sequential series includes at least a return button that is selectively activate to return to a prior screen.

8. The voter apparatus as recited in claim 1, wherein each candidate information block includes a positive graphic to indicate the selection of the candidate in response to the voter selecting one of the candidate information blocks by touching the video screen.

9. The voter apparatus as recited in claim 8, wherein the selected candidate information block in one of the ballot screens remains selected until the voter selects another of the candidate information blocks in said one of the ballot screens, whereupon the positive graphic in the selected candidate information block is changed to a negative graphic and the another of the candidate information blocks is changed to a positive graphic.

10. The voter apparatus as recited in claim 1, further comprising a summary screen providing a report of the selected candidates in the series of ballot screens and a vote selection button to finalize the vote of the voter.

11. The voter apparatus as recited in claim 10, further comprising a printer operatively connected to the central processor for printing a voter validation receipt subsequent to the voter activating the vote selection button.

12. A method of voting for one of at least one candidate for office in at least one elective races by a voter, comprising the steps of:
(a) displaying a sequential series of ballot screens, each ballot screen corresponding to one elective race and including a candidate information block associated with each of at least one candidate for election by voters in the elective race; and
(b) the voter touching a touch-sensitive video display monitor to communicating a signal representative of a selected location of a touch by a voter to a central processor, which touch is made at the display of the candidate information block for whom the voter intends to vote,
whereby the central processor detects which of the at least one candidate information blocks was selected by the voter.

13. The method of voting as recited in claim 12, further comprising the step of summing the votes for the selected one of the at least one candidate by a tabulator.

14. The method of voting as recited in claim 13, further comprising the step of recording the votes in a pair of mirrored storage devices.

15. The method of voting as recited in claim 12, further comprising the step of displaying a proposition screen having a recitation of a voter proposition and graphics images representative of the proposition and the negative of the proposition, for selection by the voter.

16. The method of voting as recited in claim 12, further comprising the step of printing a voter validation receipt subsequent to the voting by the voter.

17. The method of voting as recited in claim 12, further comprising the step of communicating the vote of the voter to a vote tabulation center over a telecommunications network.

18. The method of voting as recited in claim 12, further comprising the step of making an audible recitation to the voter of the names of the candidate prior to the voter voting.

19. The method of voting as recited in claim 12, further comprising the step of selectively moving from one ballot screen to another of said ballot screens in sequence.

20. The method of voting as recited in claim 12, further comprising the step of displaying a positive graphic in the selected candidate information block.

21. The voter apparatus as recited in claim 20, wherein the positive graphic remains displayed in the selected candidate information block in said one of the ballot screens until the voter selects another of the candidate information blocks, whereupon the positive graphic in the selected candidate information block is changed to a negative graphic and the another of the candidate information blocks is changed to the positive graphic.

22. The method of voting as recited in claim 12, further comprising the step of providing a summary screen displaying the selected candidates in the series of ballot screens for verification prior to the voter finalizing the vote.

23. The method of voting as recited in claim 22, further comprising the step of printing a voter validation receipt subsequent to the voter finalizing the vote.

24. The method of voting, further comprising the steps of:
(c) generating a voter validation number containing indicia of the voter and the voting by the voter;
(d) providing a voter validation receipt containing the voter validation number and a report of the vote by the voter; and
(e) validating the vote by the voter comparing the report of the vote with the election results tabulated by a vote tabulation center.
